(19) United States
(12) Patent Application Publication
(10) Pub. No.: US 2023/0042659 A1
(43) Pub. Date: Feb. 9, 2023

(54) COMPLEX PHOTONICS CIRCUIT FABRICATION

(71) Applicant: Meta Platforms, Inc., Menlo Park, CA (US)

(72) Inventors: Pradip Sairam Pichumani, Bellevue, WA (US); Sandeep Rekhi, San Jose, CA (US)

(21) Appl. No.: 17/392,862

(22) Filed: Aug. 3, 2021

(51) Int. Cl. B28D 5/00; B28D 1/00

(52) U.S. Cl. CPC B28D 5/0082; B28D 1/003

(57) ABSTRACT

The disclosed system may include a slicing component that has a cutting blade. The cutting blade may be configured to cut a semiconductor wafer into multiple wafer strips, where the wafer strips have flat top surfaces and multiple edges. The system may also include a chuck that has rotatable wafer plate strips that are respectively configured to support the wafer strips. The system may further include a pivot arm that rotates the chuck from a cutting position facing the slicing component to a rotated, polishing position that faces a polishing component. As such, an exposed edge of each wafer strip faces the polishing component. The system may also include a polishing component that is configured to polish at least a portion of the exposed edge of each wafer strip that is facing the polishing component. Various other methods, systems, and computer-readable media are also disclosed.

### BRIEF DESCRIPTION OF THE DRAWINGS

The accompanying drawings illustrate a number of exemplary embodiments and are a part of the specification. Together with the following description, these drawings demonstrate and explain various principles of the present disclosure.

FIGS. 1A and 1B illustrate perspective views of a combined semiconductor wafer cutting and polishing system.

FIGS. 2A-2C illustrate perspective views of a combined semiconductor wafer cutting and polishing system in a loading position, in a cutting position, and in a polishing position.

FIGS. 3A-3E illustrate perspective, top, bottom, and side views of a chuck component.

FIGS. 4A-4E illustrate side perspective views of a chuck configured to support cutting and rotating wafer strips for polishing.

FIGS. 5A-5E illustrate side views of a chuck configured to support cutting and rotation of wafer strips for polishing.

FIGS. 6A-6E illustrate side views of a chuck along with a semiconductor wafer that has been cut into strips and is prepared for polishing.

FIGS. 7A and 7B illustrate perspective and side views, respectively, of a cutting device.

FIGS. 8A-8C illustrate top and perspective views of a polishing component and a chuck configured to hold semiconductor wafers for polishing.

FIGS. 9A-9J illustrate a sequence in which a semiconductor wafer is cut into strips and each wafer strip is polished, and then potentially cut again into a die.

FIG. 10 is a flow diagram of an exemplary method for cutting a semiconductor wafer into strips and polishing the wafer strips.

FIG. 11 is an illustration of exemplary augmented-reality glasses that may be used in connection with embodiments of this disclosure.

FIG. 12 is an illustration of an exemplary virtual-reality headset that may be used in connection with embodiments of this disclosure.

Throughout the drawings, identical reference characters and descriptions indicate similar, but not necessarily identical, elements. While the exemplary embodiments described herein are susceptible to various modifications and alternative forms, specific embodiments have been shown by way of example in the drawings and will be described in detail herein. However, the exemplary embodiments described herein are not intended to be limited to the particular forms disclosed. Rather, the present disclosure covers all modifications, equivalents, and alternatives falling within the scope of the appended claims.

### DETAILED DESCRIPTION OF EXEMPLARY EMBODIMENTS

Semiconductors are traditionally produced in wafers having multiple different layers. These wafers are then cut into dies and are used in a variety of different technologies and electronic devices. In some cases, one or more edges of the wafer dies may be polished for use in photonics circuits, lasers, or waveguides. In such cases, the edges may be polished to allow for the use of edge emitting lasers such as vertical-cavity surface-emitting lasers (VCSELs). Traditional methods for producing such polished dies involved manually polishing each sample to the correct layer and thickness. This manual polishing is time consuming and operator dependent. As such, each operator may polish the dies in a different fashion, and to different depths. This, in turn, leads to an uneven distribution of polish among the various dies.

Some conventional systems have attempted to automate this wafer polishing process. However, even automated systems do not allow for large-scale automated wafer-level polishing. For instance, traditional automated wafer polishing systems are designed to pick up each individual die by itself and then polish them one at a time. This process, though automated, remains time consuming and inefficient.

In contrast, the embodiments described herein provide methods and systems that allow for the designing and fabrication of compact silicon photonics integrated circuits, among other potential types of circuits. These embodiments may provide an automated, high-volume solution to produce semiconductor dies with polished or mirror-finished edges. These polished edges may allow for edge coupling and butt coupling of photonic integrated circuits. Such circuits may be used in high-volume server communications and in other fields of technology. The systems described herein may provide an effective means of fabricating optical components such as ridge waveguides. These ridge waveguides may have improved optical performance over those created using traditional methods, as each of the edges, using the systems herein, may be polished to the same depth and at the same angle. Fully automated systems, such as those described herein, may reduce the number of artifacts that are traditionally created during the manual process, and may reduce each silicon wafer's production time. In some cases, as will be explained further below, the polishing may affect the evanescent field of a fabricated device. In some cases, the systems herein may reduce the evanescent field of a device to a specified (and potentially more desirable) thickness.

The embodiments described herein may include a wafer chuck that is configured to hold a full wafer (un-diced) semiconductor wafer. These systems may also include a slicing component that slices the wafer into columns, as well as a rotation system that rotates all of the individual columns 90 degrees (or to some other desired angle) at the same time. Still further, these systems may include a polishing component (e.g., a chemical-mechanical planarization (CMP) machine) that polishes the exposed edges of the rotated wafer columns. After the polishing, the columns may be rotated back into their original flat position, and the columns may be diced in a transverse direction to form individual dies that each have at least one polished edge. These systems may be configured to slice substantially any size of semiconductor or any kind of wafers, and may be configured to uniformly polish a large number of dies simultaneously (e.g., dozens, hundreds, or thousands, depending on the chip size and wafer size). In some embodiments, the slicing component and the polishing component may be combined into the same system or apparatus. As such, the cut semiconductor columns do not need to be transferred large distances to a polishing component. This greatly reduces transfer time and increases fabrication efficiency. This may also reduce the industrial footprint of the device, as the chuck, slicing component, and polishing component are all part of the same apparatus.

Features from any of the embodiments described herein may be used in combination with one another in accordance with the general principles described herein. These and other embodiments, features, and advantages will be more fully understood upon reading the following detailed description in conjunction with the accompanying drawings and claims.

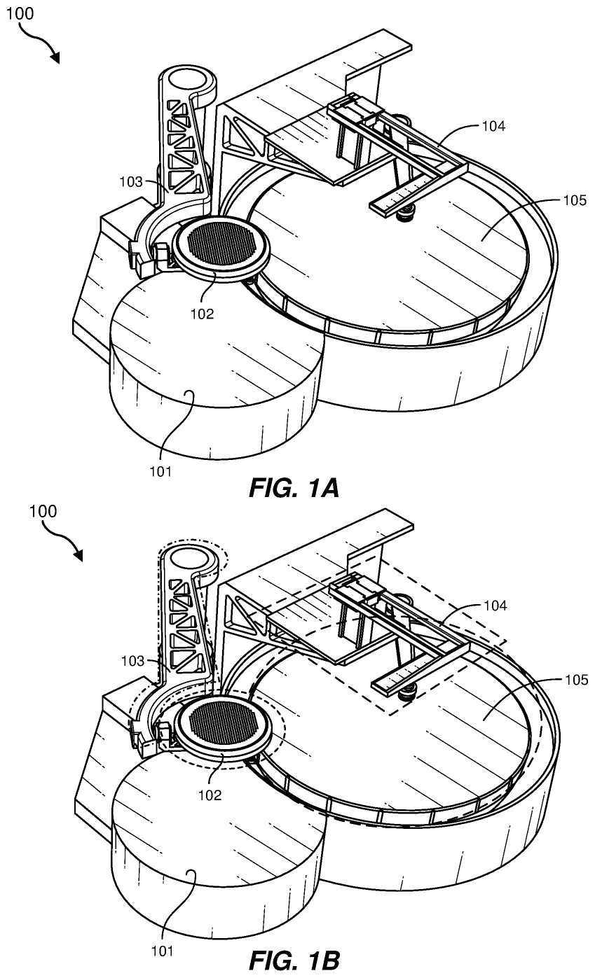

The following will provide, with reference to FIGS. 1A-12, detailed descriptions of various systems, methods, apparatuses, and computer-readable media that comprise and/or control a combined semiconductor wafer cutting and polishing system. For example, the combined semiconductor wafer cutting and polishing system 100 of FIG. 1A includes different components, devices, or subparts that may work together to access a semiconductor wafer, slice the wafer into strips, polish those wafer strips, and then further cut the polished wafer strips into dies, each of which has at least fone polished side. In this combined semiconductor wafer cutting and polishing system 100, a loading and unloading station 101 may be implemented to store and/or load semiconductor wafers onto a chuck 102. The chuck 102 may be configured to hold the semiconductor wafer while it is being sliced into columns or strips. A movement arm 103, controlled by an electronic controller (e.g., a programmable logic device (PLD), system on a chip (SoC), or similar), may move the semiconductor wafer held by the chuck 102 to a cutting station or cutting component 104. The cutting component 104 may be configured to cut the semiconductor wafer into multiple strips.

After the wafer has been cut into columns or strips, multiple rotatable wafer plate strips may rotate the cut strips to a vertical position (or may rotate the strips to some other specified angle relative to the horizontal chuck 102). The chuck itself may then be rotated about its horizontal axis so that the (now cut and rotated) semiconductor wafer strips are moved into a position that is perpendicular to the surface of the polishing component 105. The polishing component 105 may then begin to spin (or continue spinning) its polishing surface. The movement arm 103 may move the chuck 102 toward the polishing component 105 to polish the exposed edges of the semiconductor wafer strips. The polishing may continue until the desired region of interest or depth of polish has been reached.

In some cases, the movement arm 103 may then rotate the chuck about its horizontal axis so that the semiconductor wafer faces the cutting component 104. The movement arm 103 may again rotate the chuck 102, this time clockwise (or counterclockwise), so that the wafer strips are turned 90 degrees relative to the cutting blade. The cutting blade of the cutting component 104 may then cut the wafer strips into small square dies. FIG. 1B includes superimposed dotted lines to show the general size and positioning of each component of the combined semiconductor wafer cutting and polishing system 100, at least in the illustrated embodiment. As will be shown below, these components may be manufactured in many different sizes and shapes, and may be designed to work in unison to mass produce polished silicon wafers with much less travel time between steps, and with a much smaller industrial footprint. This smaller footprint may allow more such machines to be used in a given building with limited floorspace, or may allow room for additional manufacturing machines that previously would not have fit on the building floor.

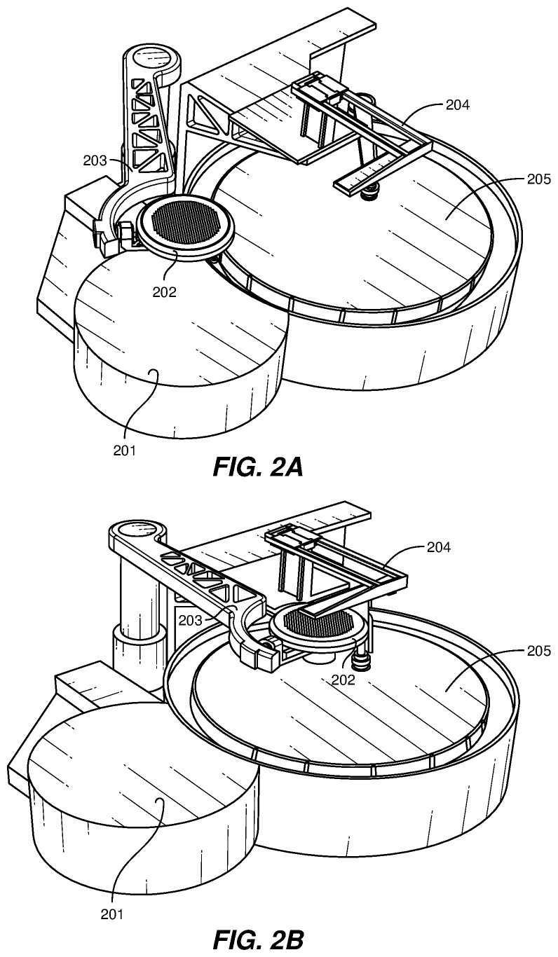

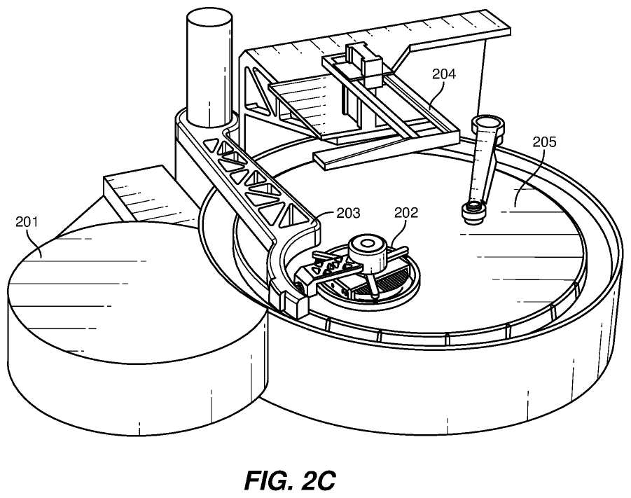

FIGS. 2A-2C illustrate embodiments in which a combined semiconductor wafer cutting and polishing system is transitioned between different positions. For instance, the combined semiconductor wafer cutting and polishing system may be in a loading position in FIG. 2A, in a slicing/dicing position in FIG. 2B, and in a polishing position in FIG. 2C. As can be seen in FIG. 2A, for example, the chuck 202 (which may be the same as or different than chuck 102 of FIG. 1A) may start in a position next to the loading/unloading station 201 where a silicon wafer (not shown) may be loaded onto the chuck 102. The movement arm 203 of the combined semiconductor wafer cutting and polishing system may then move the chuck 202 to a slicing position in FIG. 2B. In the slicing position, the chuck 202 may secure the semiconductor wafer in place so that as the cutting blade of the cutting device 204 cuts the wafer into strips, the cut strips or columns are each supported by the chuck 202.

The movement arm 203 may then rotate the chuck 202 so that it faces downward toward the polishing station 205, and may rotate each of the wafer strips to a 90-degree position that is orthogonal to the chuck. The movement arm 203 may also lower the chuck 202 toward the surface of the polishing station 205. The polishing station 205 may begin spinning or may continue to spin as the movement arm 203 lowers the chuck 202 onto the polishing surface of the polishing station 205. This lowering may cause the exposed edges of the cut wafer strips to contact the polishing surface. This contact may polish the exposed edges of the wafer strips. In some cases, the movement arm 203 may then move the chuck back to the cutting position to further cut the (polished) semiconductor wafer strips into chips or dies. These dies may then be further polished if desired by again rotating and lowering the chuck to a position where the wafer dies contact the surface of the polishing station 205.

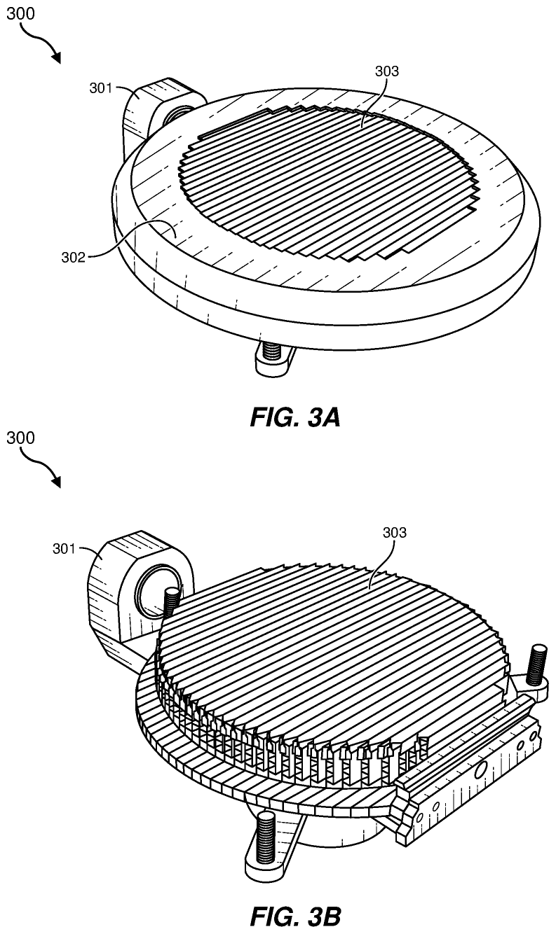

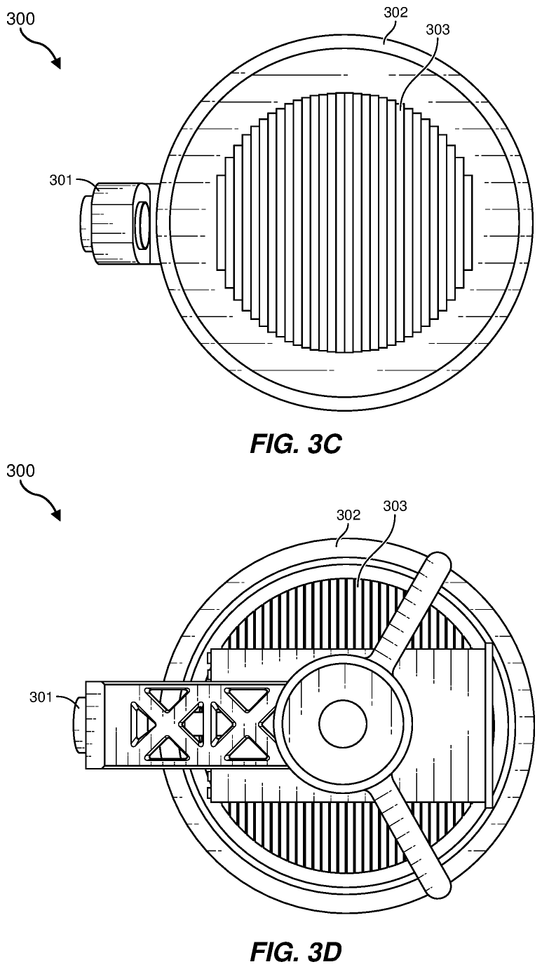

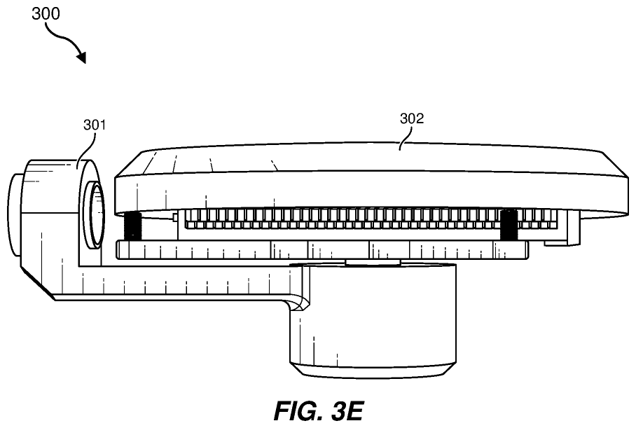

FIGS. 3A-3E illustrate an embodiment of a chuck 300 that has multiple component parts. For instance, the chuck 300 (which may be the same as or different than the chuck 102 of FIG. 1A or the chuck 202 of FIG. 2A) may include an outer housing 302, a rotating member 301 (which may be connected to a movement arm), and multiple rotatable wafer plate strips 303. In some cases, the chuck 300 is formed in the shape of a circle, but it should be understood that substantially any shape may be used including square, rectangle, triangle, oval, etc. Moreover, the chuck 300 may include substantially any number of rotatable wafer plate strips 303. Each rotatable wafer plate strip 303 may be configured to support at least a portion of a semiconductor wafer. In some cases, the chuck 300 may include one rotatable wafer plate strip for each wafer strip or wafer column that is created by the cutting device. In other cases, one rotatable wafer plate strip may support two, three, or more semiconductor wafer strips. In some cases, the widths of the rotatable wafer plate strips 303 are uniform, and in other cases, the widths may vary, with some being wider or narrower than other plate strips. In some cases, the length and height of the rotatable wafer plate strips may also vary in certain cases. In the embodiments shown in FIGS. 3A-3E, each of the rotatable wafer plate strips 303 are the same width and same height, with differing lengths to accommodate the round shape, although variations of width, length, or height may be used as desired.

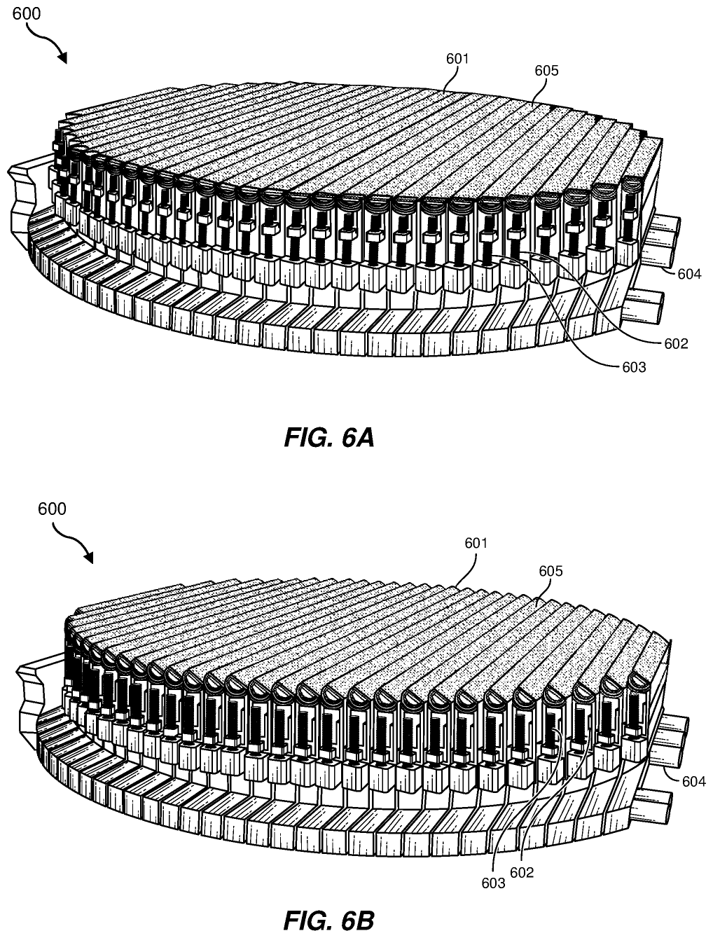

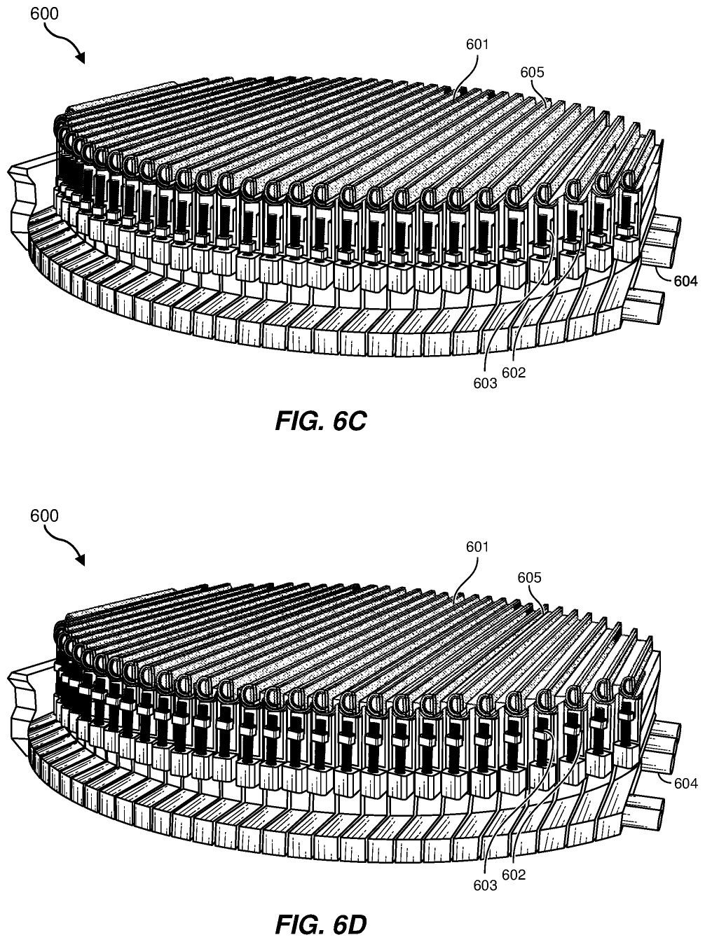

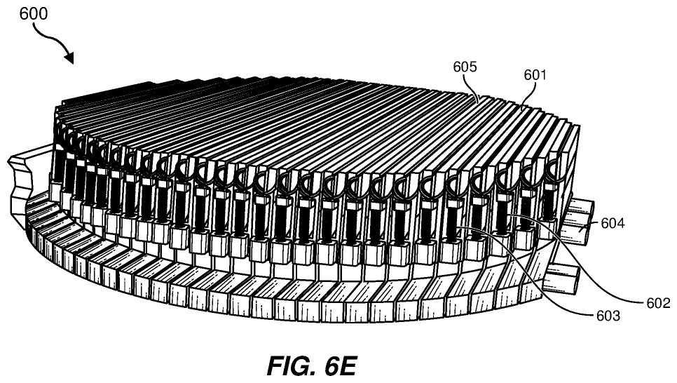

The rotatable wafer plate strips 303 may be made of metal, metal alloys, porcelain, or other materials. In some cases, as shown in FIGS. 6A-6E, each rotatable wafer plate strip may have a silicon wafer strip affixed or adhered to it. For example, the systems herein may implement heat release glue, ultraviolet (UV) release glue, or other adhesives to adhere the wafer strips to the rotatable wafer plate strips. In other cases, clips, screws, or other fasteners may be used to (at least temporarily) affix the wafer strips to the rotatable wafer plate strips 303. In still other cases, vacuum tubes or other similar means may be implemented to vacuum seal the wafer strips to the rotatable wafer plate strips 303. Accordingly, it should be understood that substantially any type of adhesive or fastener may be used to at least temporarily adhere the wafer strips (or dies) to the rotatable wafer plate strips 303. Similarly, it should be understood that while silicon wafer plates, wafer strips, and wafer dies are referred to herein, these embodiments may be configured to work with wafers made out of substantially any type of material or combination of materials.

FIG. 3B illustrates the chuck 300 without the outer housing 302. In some cases, the rotatable wafer plate strips 303 may be slightly recessed relative to the housing. This recessed gap may allow the housing 302 to function as a support structure that holds the silicon wafer in place. FIG. 3C illustrates a top view of the chuck 300, while FIGS. 3D and 3E illustrate bottom and side views of the chuck, respectively. The chuck 300 may be configured to support 100 mm, 150 mm, 200 mm, 300 mm, and/or other size wafers. The chuck 300 may provide a smooth mounting surface during initial placement of the semiconductor wafer, with all rotatable wafer plate strips aligned to create a flat surface, and may provide a 90-degree tilted position (or other specified degree) when polishing the exposed edges of the respective wafer strips that are mounted to the rotatable wafer plate strips 303.

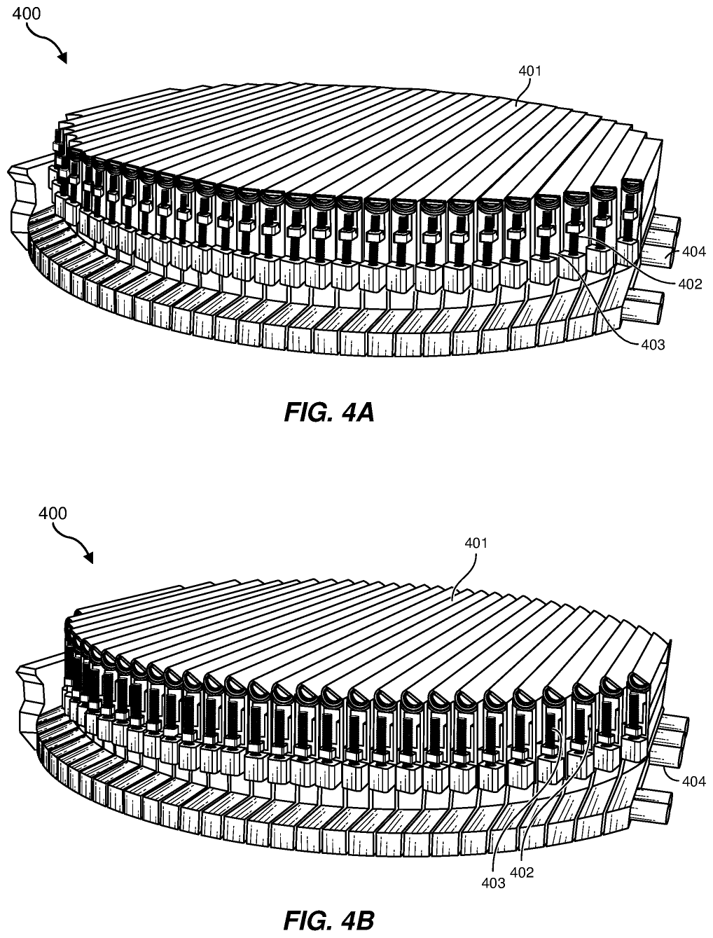

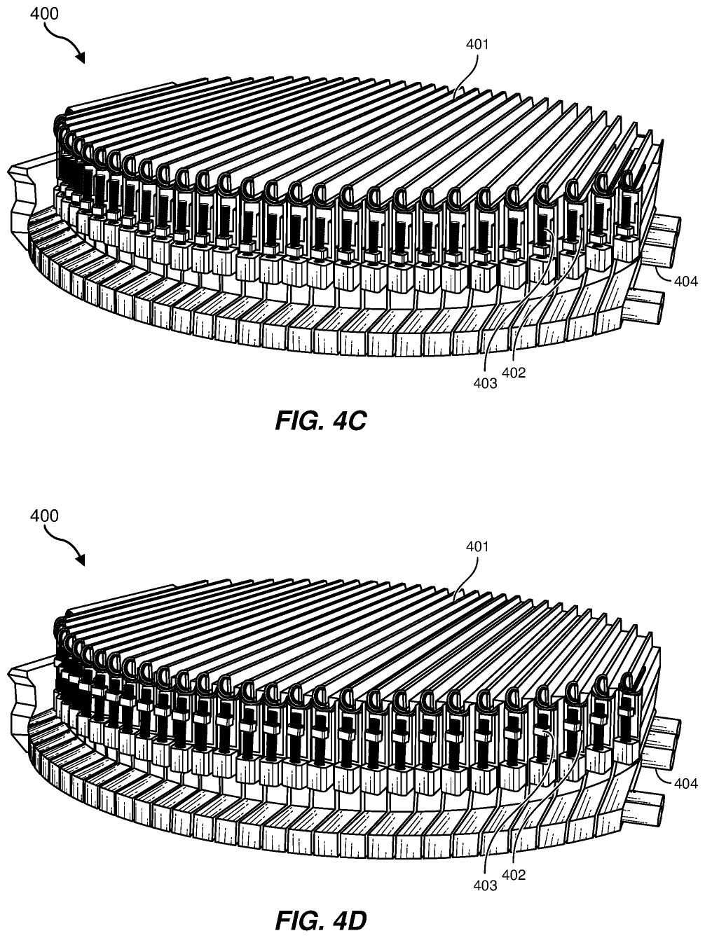

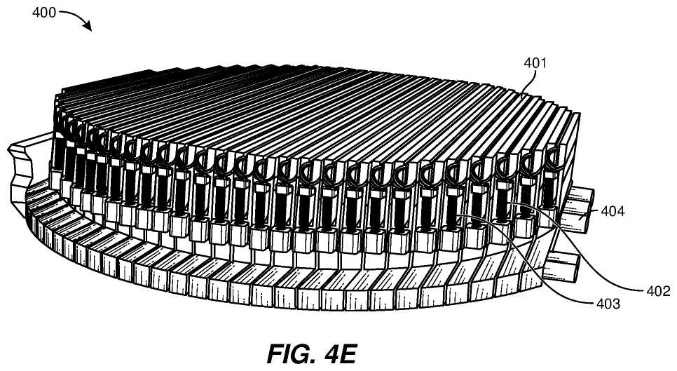

FIGS. 4A-4E illustrate close-up, perspective views of an example chuck 400. The chuck 400 (which may be the same as or different than the chucks in FIGS. 1A-3E) may include multiple rotatable wafer plate strips 401 that are each configured to support corresponding semiconductor wafer strips that have been cut from a semiconductor wafer. These wafer strips have one or more cut edges that may be exposed for polishing. The chuck 400 may also include one or more blocking components 402. These blocking components may be mounted to supports 403 that may be threaded to allow for movement of the blocking components or “blockers” 402. The blockers 402 may be configured to abut the rotatable wafer plate strips 401 and, when the rotatable wafer plate strips are (at least partially) rotated, may extend to the outer edge of the semiconductor wafer (as shown in FIG. 4E). The chuck 400 may also include one or more motor units 404 that are configured to transfer a motive force to the blocking components 402 and/or rotate the rotatable wafer plate strips 401. Still further, the chuck 400 may include a housing (not shown) that is similar to or the same as housing 302 of FIG. 3A, and at least partially surrounds the rotatable wafer plate strips 401.

FIGS. 4A-4E illustrate a progression in which the rotatable wafer plate strips 401 are rotated from an initial flat position to a 90-degree rotated position. Although many embodiments shown and described herein implement a 90-degree rotation to perform the polishing, the motor units 404 may be configured to rotate the rotatable wafer plate strips 401 to substantially any degree of rotation. Between FIGS. 4A and 4B, the rotatable wafer plate strips have been rotated approximately 45 degrees, on their way to a full 90-degree rotation shown in FIG. 4C. In some cases, the motor units performing or causing the rotatable wafer plate strips to rotate may be servo motors. In some cases, a separate servo motor controls each rotatable wafer plate strip individually. In other cases, a single servo motor may be connected to gears or pulleys that cause all of the rotatable wafer plate strips 401 to rotate together.

FIGS. 4D and 4E illustrate how blockers 402 may be raised up to a position that is even with the cut wafer strips or potentially is just above or below the outer edge of the wafer strips. The blockers 402 may be configured to hold or secure the wafer strips in place while the polishing is performed. The blockers 402 may be made of substantially any durable material that may withstand multiple polishes, including tungsten carbide, boron nitride, or other similar materials. In some cases, the height of the blockers 402 relative to the exposed edges of the cut wafer strips may be continually adjusted during polishing. These height adjustments may be applied to individual blockers or to all of the blockers together as a group. Indeed, in some cases, each blocker may be controlled by its own motor unit, while in other cases, the blockers may be controlled and moved collectively as a group with a single motor unit. At least in some cases, these blocker motor units may be separate from motor units that control the rotation of the rotatable wafer plate strips.

The height of the blockers may be continually adjusted to ensure that the wafer strips' edges are not being pressed too firmly or too far into the polishing surface, while still being pressed firmly enough to appropriately polish the edges to a specified depth. In some cases, a separate electronic controller (e.g., a PLD or system on a chip (SoC), etc.) may be implemented to control the blockers. This blocker controller may be separate from or the same as the controller that controls the other components of the combined semiconductor wafer cutting and polishing system including the rotatable wafer plate strips. The electronic components (e.g., a processor, memory, a logic device, a networking radio, etc.) may be housed in the loading/unloading station, or may be housed in another component.

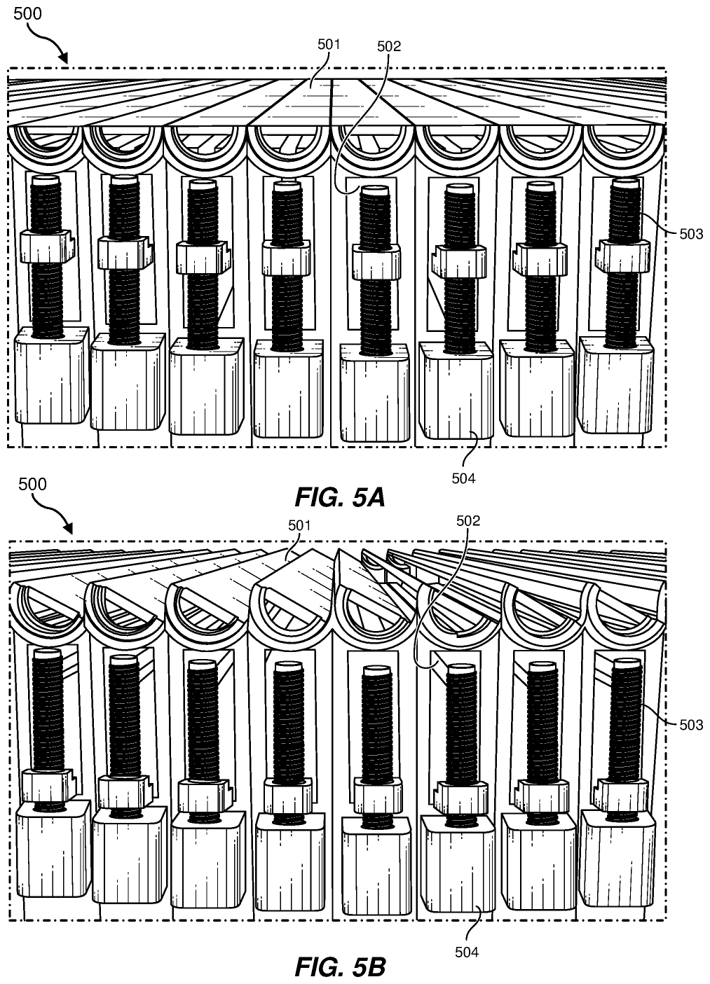

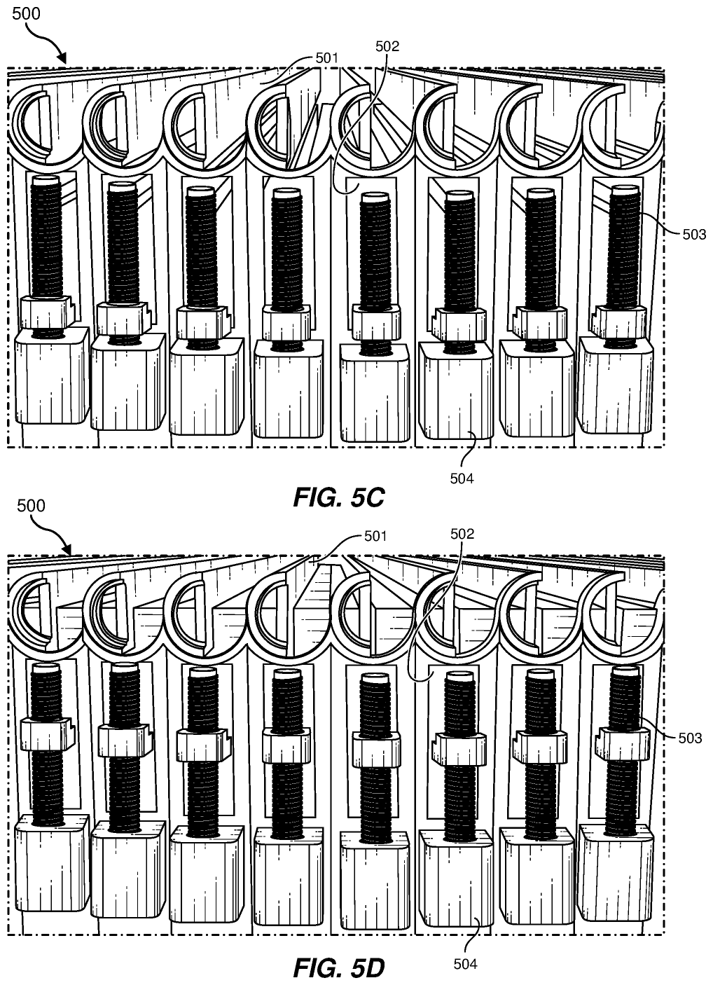

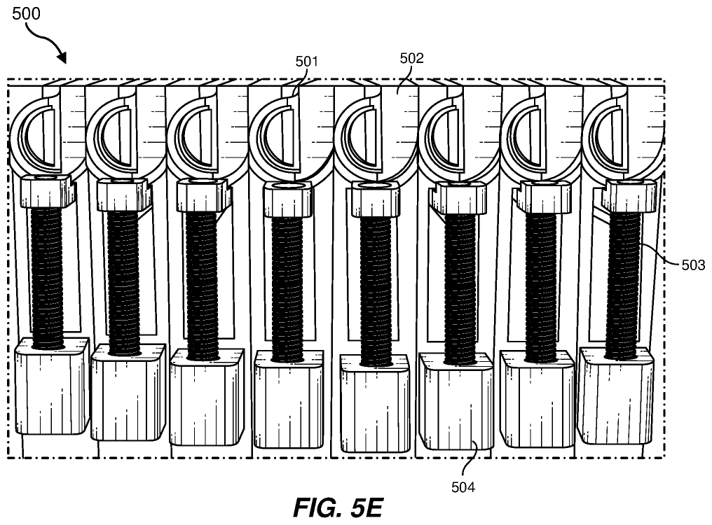

FIGS. 5A-5E illustrate chuck 500 that includes multiple rotatable wafer plate strips 501. Each rotatable wafer plate strip 501 may be semi-circular in shape, having a top, flat edge, and a bottom curved edge. The rotatable wafer plate strips 501 may be linked, clipped, or otherwise connected to gears or pulleys or other mechanical or electromechanical means of rotating the wafer plate strips 5010 about a transverse or horizontal axis relative to the top surface of the chuck 500. Similarly, each rotatable wafer plate strip 501 may have one or more corresponding blocking components 502. Each of these blocking components 502 may be moved up and down via a gearing system 503, or via some other movement generating mechanism. The gearing system 503 may include a base 504 for each threaded stabilizer. Such threading may allow for precise movement of the blockers. Similar gearing may be used to transfer motion to the rotatable wafer plate strips 501.

In FIG. 5A, the rotatable wafer plate strips 501 begin in a flat position. Servo motors or some other type of motor units may provide power that rotates the rotatable wafer plate strips 501 clockwise (in this embodiment) toward the blocking components 502, as shown in FIG. 5B. Once the rotatable wafer plate strips 501 have reached the specified angle (e.g., 90 degrees), as shown in FIGS. 5C & 5D, the blocking components 502 may be moved up toward the top surface of the chuck 500 and towards the outer edge of the (now rotated) wafer strips (not shown here, but shown in FIGS. 6A-6E). FIG. 5E illustrates the blocking components 502 in their final position, ready to be moved along with the chuck onto the surface of the polishing component.

FIGS. 6A-6E illustrate the same (or similar) chuck 600 as that shown in FIGS. 4A-4E, except in this embodiment, a silicon wafer has been added to illustrate how the chuck works with a sample of material. The semiconductor wafer may be made of silicon or other semiconductor materials. In some cases, different types of objects other than semiconductor wafers may be cut and polished using the system described herein. The silicon wafer may have been loaded onto the chuck 600 and sliced into wafer strips 605, as shown in FIG. 6A, the wafer strips 605 sit atop the rotatable wafer plate strips 601. In this illustration, each rotatable wafer plate strip 601 has a corresponding wafer strip 605, although this need not always be the case.

As in FIGS. 4A-5E, the rotatable wafer plate strips 601 may begin in a flat position, as shown in FIG. 6A, and may be rotated while adhered to the rotatable wafer plate strips 601 to different angles, as shown in FIGS. 6B and 6C. The wafer strips may be adhered to the rotatable wafer plate strips 601 using temporary glue, using fasteners such as clips, using vacuum seals, or using some other fastening means. Accordingly, as the rotatable wafer plate strips 601 tilt, the cut wafer strips 605 tilt in a corresponding manner. As each wafer strip is rotated about a transverse or horizontal axis relative to the chuck 600, the exposed edge of each wafer strip now at least partially faces the polishing component. FIGS. 6D and 6E illustrate how the blocking components 602 are raised on support structures 603, as controlled by motor units 604. These blocking components 602 leave a gap to accommodate the wafer strips 605. Then, once moved into place, the blocking components 602 support the wafer strips 605 and hold the wafer strips in place, providing a secure position in which to be polished. The chuck 600 may then be rotated on its movement arm 180 degrees to face the polishing component, and may be lowered onto the surface of the polishing component to be polished.

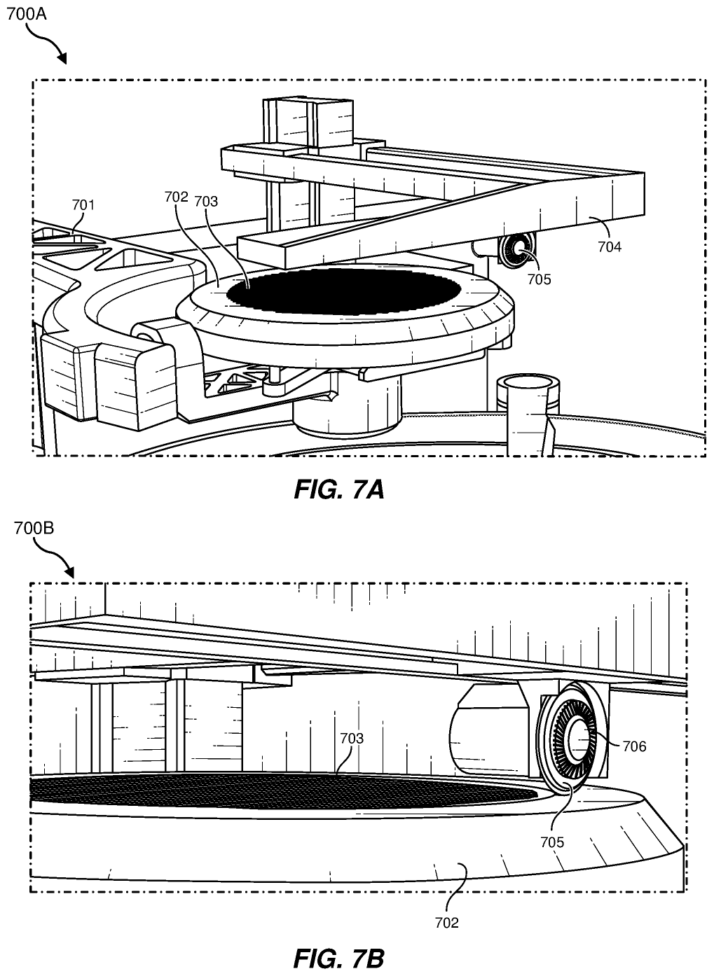

In some embodiments, the polished wafer strips may be cut again into chips or dies. For instance, as shown in FIG. 7A, the cutting device 700A may perform initial longitudinal cuts using cutting blade 705. The chuck's movement arm 701 may move the chuck 702 into place below the cutting device 700A, and the cutting device's movement arm 704 may move the blade into place to make the longitudinal cuts. The wafer strips may remain on the rotatable wafer plate strips 703 while the wafer plate strips are rotated, and the strips' edges are polished. After the polishing, the chuck's movement arm 701 may again move the chuck 702 into the cutting position below the cutting blade 705. However, the chuck 702 may be configured to rotate the wafer strips 90 degrees clockwise (or counterclockwise) in order to cut the wafer strips into dies. As shown in FIG. 7B, the cutting device 700B may direct the cutting blade 705, along with its flange 706 and other component parts, over the wafer strips to dice them into squares. In some cases, the rotatable wafer plate strips 703 may continue to hold the dies after they are cut, and may rotate the dies on a transverse axis, so they are again perpendicular to the top surface of the chuck. The chuck itself may then be rotated to face downward toward the polishing station, where the dies may be polished on a second side. This process may be repeated up to four times, so that, if desired, all four edges of the dies are polished for laser, waveguide, and other applications.

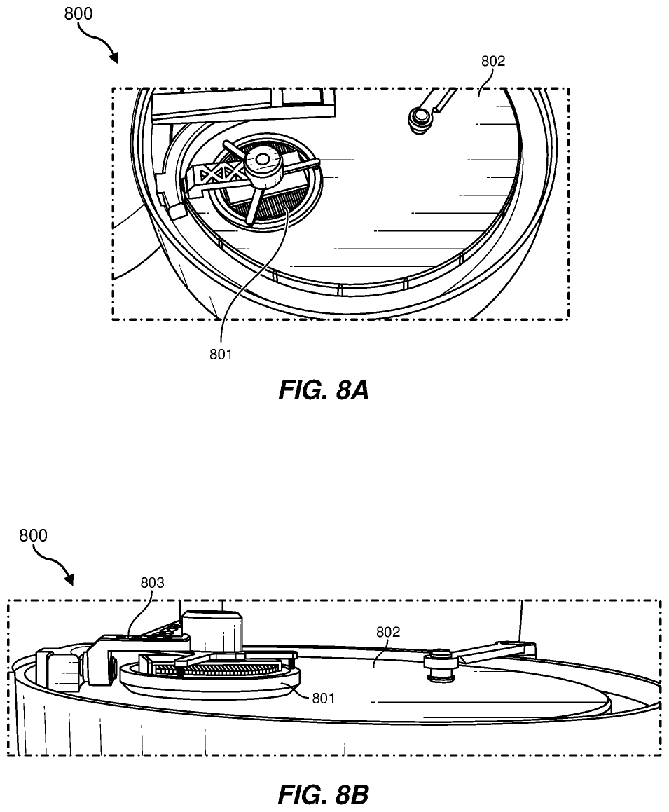

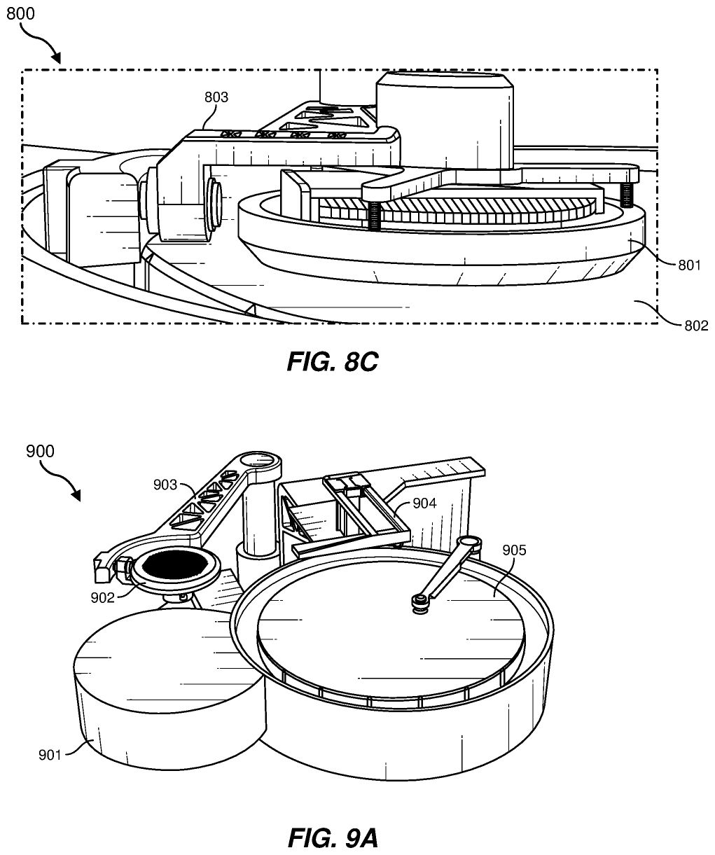

FIGS. 8A-8C illustrate a polishing station 800. The polishing station may include a polishing pad 802 that is used to polish the exposed edges of the wafer strips. In some cases, the polishing station 800 may implement a pad conditioner designed to ensure that the polishing pad remains lubricated with the various slurries throughout the polishing process. Moreover, the pad conditioner may be further configured to provide flatness to the polishing pad 802 by reducing unevenness in the polishing process. In some cases, the polishing station may be a chemical-mechanical planarization (CMP) machine. In such cases, the chuck 801 may be lowered onto the polishing pad 802 of the polishing station 800 using the movement arm 803.

FIG. 8A illustrates a top perspective view of a chuck 801 in position to polish the exposed edges of its wafer strips on the polishing pad 802. FIG. 8B illustrates a side perspective view of the polishing pad 802 and the chuck 801, while FIG. 8C illustrates a zoomed-in side perspective view that more closely illustrates how the chuck 801 contacts the polishing pad 802. In some cases, the blocking components (e.g., 602 of FIG. 6A) may be retracted upon contacting the polishing pad 802. For instance, sensors in the movement arm 803 may receive pressure feedback indicating that the chuck 801 has contacted the polishing pad surface. In such cases, upon detecting this pressure, the movement arm 803 will cease moving the chuck toward the polishing pad surface. When the wafer strips have finished polishing, the blocking components may be retracted to cover and protect the polished edges of the wafer strips. This may ensure that the polish on the wafer strips remains pure and clear for waveguide, laser, and other similar photonics applications.

Indeed, at least some photonics implementations may involve connecting two photonics chips together. In the embodiments herein, the combined cutting and polishing station may polish the corresponding edges of photonics chips that are to be connected (e.g., via a butt joints or miter joints). In some cases, the photonics chips may be beveled to corresponding angles so that the photonics chips fit together. In such cases, the blocking components may be lowered to specified levels to provide the proper angle on each wafer strip's bevel. This may allow optic fibers, lasers, or other photonics circuitry to enter or exit the polished edges at a certain angle that provides a proper transfer between the optic fiber and, for example, a waveguide's gradient coupler. In cases where multiple sides of a photonics chip are to be polished (either to the same angle or to different angles), the chuck may be rotated 90 degrees clockwise to allow the cutting station to repeatedly cut the wafer strips into dies or chips, which can then be polished by the polishing station.

In some cases, if desired, different edges of the same wafer strip may be polished at different angles. Thus, a single chip could have four outside edges, with each edge polished to a different angle. These different angles may provide different offsets that allow the exposed edges of corresponding wafer strips to abut each other in different geometries. This allows light from one polished chip to jump to another chip (e.g., to a waveguide) through evanescent coupling. This may occur even if the chips are not touching as long as the gap and angle between the chips is taken into consideration. These embodiments may thus be configured to provide polished photonics chips that may work with all different types of semiconductor wafers, and may be used in many different types of applications including high-speed data communications, server-to-server links, optical communications, optical biosensors, edge-emitting lasers, etc.

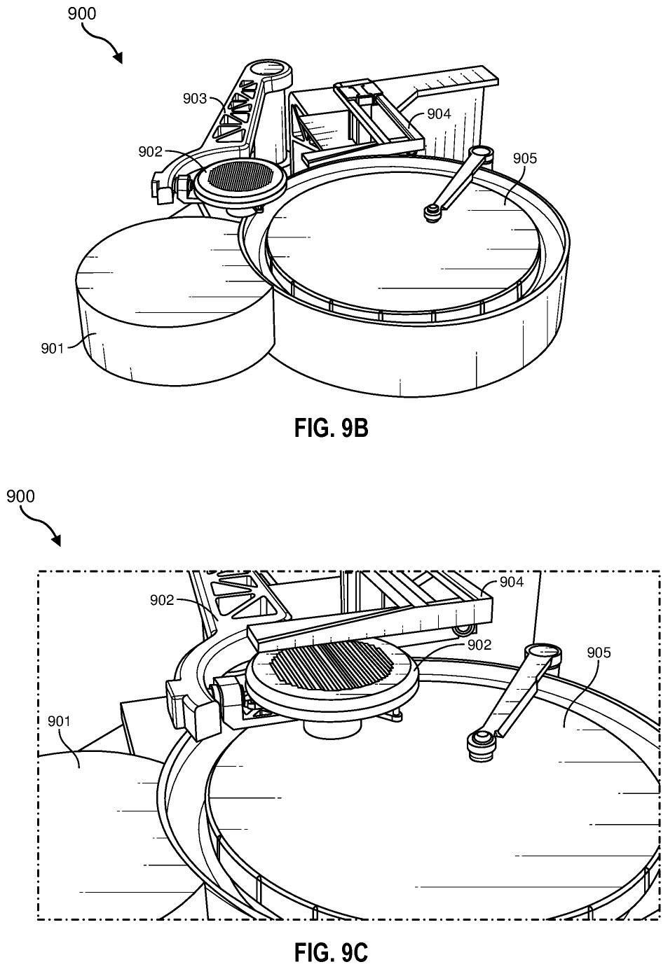

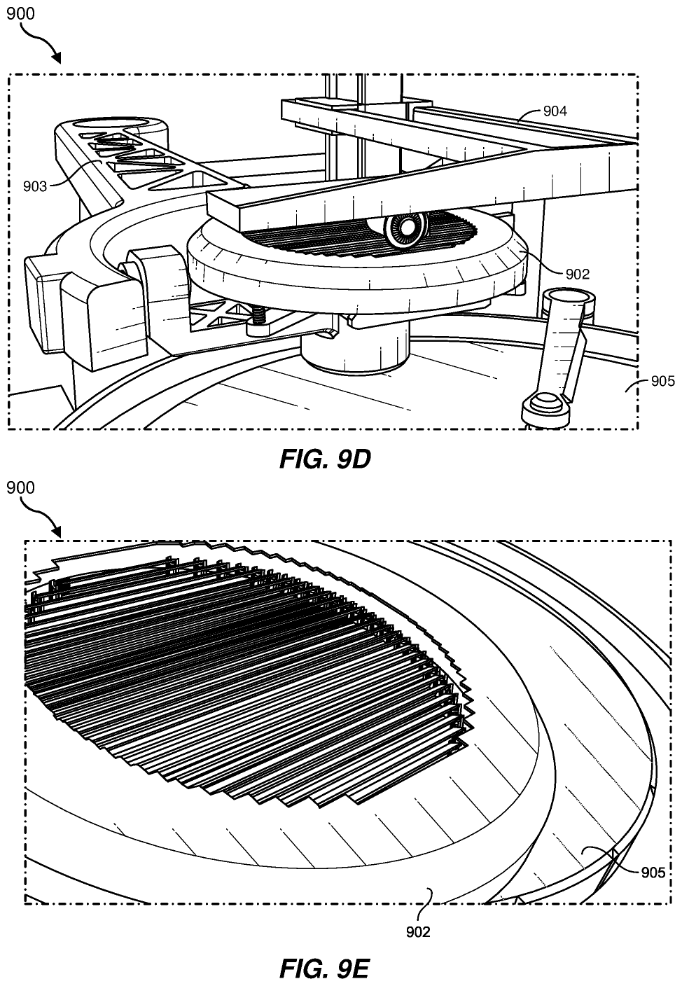

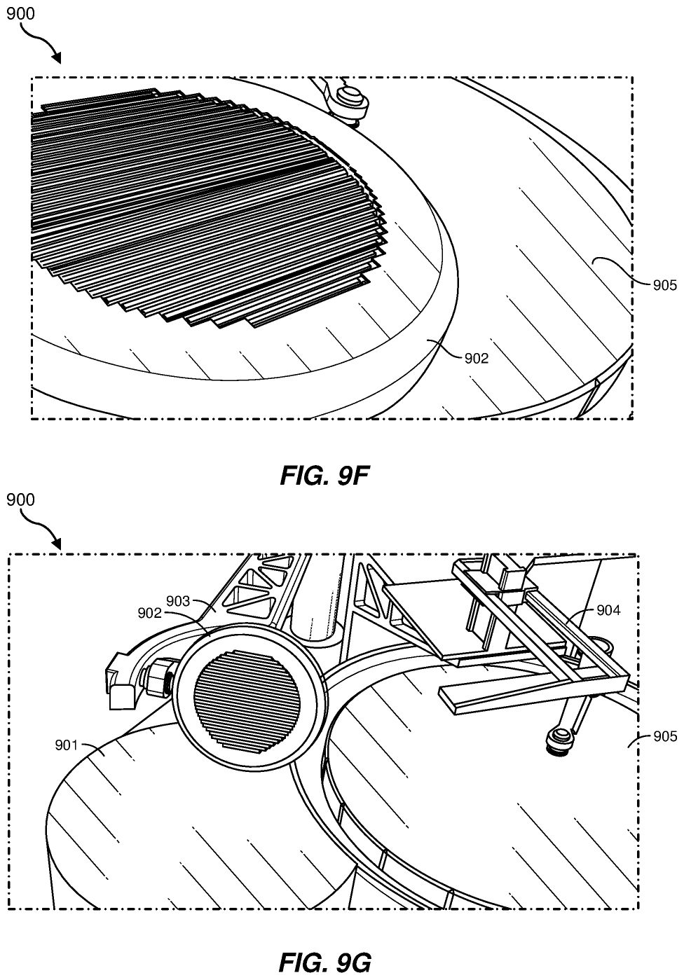

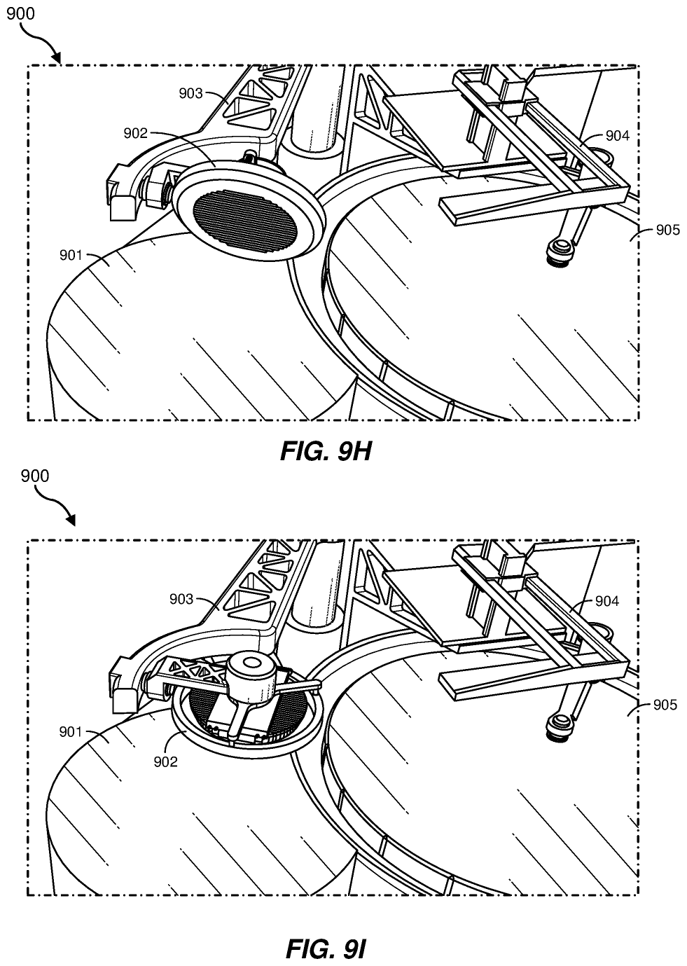

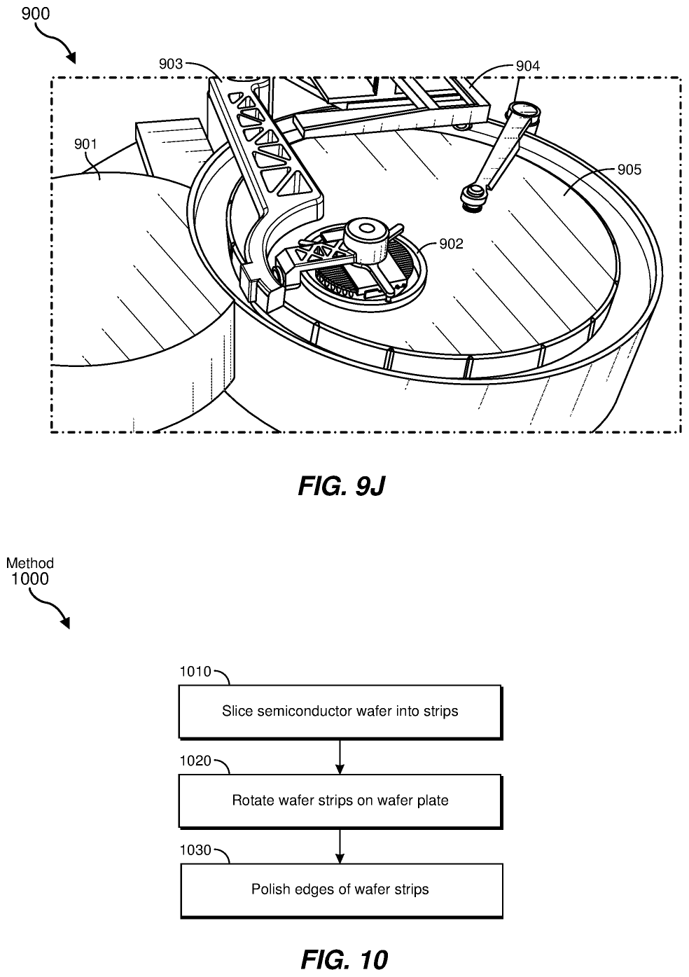

FIGS. 9A-9J illustrate a sequence in which a semiconductor wafer is sliced and polished at a combined slicing and polishing station 900. This sequence will be described with reference to the method flow of FIG. 10. FIG. 10 is a flow diagram of an exemplary computer-implemented method 1000 for slicing and polishing a semiconductor wafer. The steps shown in FIG. 10 may be performed or controlled by any suitable computer-executable code and/or computing system, including a programmable logic device, electronically erasable read only memory, or similar hardware or firmware device. In one example, each of the steps shown in FIG. 10 may represent an algorithm whose structure includes and/or is represented by multiple sub-steps, examples of which will be provided in greater detail below.

At step 1010, the method 1000 may include slicing a semiconductor wafer into one or more wafer strips, where each wafer strip is supported by a corresponding rotatable wafer plate strip. Each of the wafer strips may have a flat top surface and one or more side edges. The method 1000 may then include, at step 1020, rotating the wafer strips on the rotatable wafer plate strips along a horizontal axis to expose at least one of the wafer strip's edges for polishing. Then, at step 1030, the method 1000 may include polishing at least a portion of the wafer strip edges while the wafer strips are in the rotated, polishing position. Optionally, the polished wafer strip may then be moved back into a cutting position where the polished wafer strips are cut into dies.

FIG. 9A illustrates a combined slicing and polishing station 900 that may begin by loading a semiconductor wafer from a loading station 901 onto a chuck 902. The pivot arm or movement arm 903 may move the chuck into a position below the cutting station 904, as shown progressively in FIGS. 9B and 9C. FIG. 9D illustrates the cutting station 904 cutting the semiconductor wafer longitudinally into strips. In FIG. 9E, the rotatable wafer strip plates of the chuck 902 may be rotated on a transverse axis relative to the top surface of the chuck, so that one side of each wafer strip is exposed. In FIG. 9F, the blocking components slide upward and support the rotated wafer strip plates and the wafer strips that are attached to those plates. In FIG. 9G, the chuck itself is rotated 180 degrees to no longer face the cutting station 904, but instead face the polishing station 905. In FIGS. 9H and 91, the chuck 902 finishes its rotation and is now facing the polishing station 905. In FIG. 9J, the movement arm 903 may lower the chuck 902 onto the surface of the polishing station 905. The chuck 902 may lower the blocking components to allow the wafer strips to be exposed to the surface of the polishing station 905.

In this manner, the exposed surfaces of each of the respective wafer strips is polished to a desired angle and/or depth. As noted above, in some cases, the movement arm 903 moves the chuck away from the surface of the polishing station, and rotates the chuck 902 back 180 degrees to again face the cutting station 904. In this position, the chuck 902 may be rotated clockwise (or counterclockwise) by 90 degrees to cut the wafer strips into wafer dies. If additional edges of the wafer dies are to be polished, the chuck and its rotatable wafer strip plates may move as many times as necessary to polish each of the sides that are to be polished. Upon completion of this process, the combined slicing and polishing station 900 may load a new semiconductor wafer onto the chuck and start the process anew. Because the entire slicing and polishing station 900 is a single unit, the amount of time needed to transfer wafers between the loading station, the cutting station, and the polishing station is greatly reduced. This allows more wafers to be cut per given time period. Moreover, this combined unit may take up less space, providing a smaller industrial footprint, and allowing more such units to be placed on a factory floor at any given time.

In some embodiments, this combined slicing and polishing station 900 may be utilized to implement unique patterning using spin coating and lithography techniques. For example, the combined slicing and polishing station 900 may be configured to apply a spin coat in the longitudinal direction (LD) and/or the transverse direction (TD). The combined slicing and polishing station 900 may thus be implemented not only in photonic applications where optic fibers are aligned to the edge of a waveguide, but also in spin coating applications that spin coat in the LD and TD directions. In such cases, the chuck 902 may be configured to level the platform and add layers through spin coating or lithography (e.g., layers on an edge or layers on the flat side). Applying patterns to the sides of chips may allow layers from the front side to be connected to the sides, and allow for evanescent connection to other semiconductor wafers.

Thus, the combined slicing and polishing station described herein may provide a high-throughput, compact, and cost-efficient system for slicing and polishing semiconductor wafers. This system may output polished wafers at a much faster rate than traditional, manual methods and systems. Moreover, these systems are not subject to operator involvement that may lead to different angles and different depths of polishing. As such, the combined loading station, chuck, cutting station, and polishing station may provide a reliable, accurate, and precise mechanism for cutting and polishing semiconductor wafers of varying dimensions.

### Example Embodiments

Example 1: A system may include a slicing component having a cutting blade that is configured to cut a semiconductor wafer into a plurality of wafer strips, where the wafer strips have flat top surfaces and one or more edges. The system may also include a chuck that includes one or more rotatable wafer plate strips that are respectively configured to support the plurality of wafer strips that are cut by the cutting blade, a pivot arm configured to rotate the chuck from a cutting position that faces the slicing component to a rotated, polishing position that faces a polishing component, such that at least an exposed edge of the wafer strips faces the polishing component, and the polishing component that is configured to polish at least a portion of the exposed edge of the wafer strips facing the polishing component.

Example 2: The system of Example 1, further comprising a loading and unloading station configured to receive and offload the semiconductor wafer.

Example 3: The system of any of Examples 1 and 2, wherein the pivot arm transfers the semiconductor wafer from the loading and unloading station to the slicing component.

Example 4: The system of any of Examples 1-3, wherein the wafer strips are rotated about a transverse axis relative to the chuck, allowing the exposed edge of the wafer strips to at least partially face the polishing component.

Example 5: The system of any of Examples 1-4, wherein the chuck further comprises a plurality of blocking components configured to support the rotated wafer plate strips.

Example 6: The system of any of Examples 1-5, wherein the wafer plate strips are rotated under the control of at least one servo motor.

Example 7: The system of any of Examples 1-6, wherein the pivot arm is further configured to subsequently rotate the chuck, allowing the cutting blade of the slicing component to cut the wafer strips into a plurality of wafer dies.

Example 8: The system of any of Examples 1-7, wherein the pivot arm subsequently rotates the chuck from the cutting position to the polishing position to polish a second exposed edge of the wafer dies.

Example 9: The system of any of Examples 1-8, wherein the polishing component comprises a chemical-mechanical planarization (CMP) machine.

Example 10: The system of any of Examples 1-9, wherein the semiconductor wafer comprises a photonics integrated circuit.

Example 11: The system of any of Examples 1-10, wherein the chuck is configured to rotate the rotatable wafer plate strips to a specified angle, such that the exposed edge of the wafer strips are polished at the specified angle.

Example 12: The system of any of Examples 1-11, wherein different edges of the same wafer strip are polished at different angles.

Example 13: The system of any of Examples 1-12, wherein the exposed edges of different wafer strips are polished at offset angles that allow the exposed edges of the different wafer strips to abut each other.

Example 14: A chuck device may include: one or more rotatable wafer plate strips that are configured to support one or more corresponding wafer strips that have been cut from a semiconductor wafer, the wafer strips including one or more edges, one or more blocking components that are configured to abut the wafer plate strips and, upon the rotatable wafer plate strips being at least partially rotated, are configured to extend to at least one edge of the semiconductor wafer, one or more motor units configured to perform at least one of moving the blocking components or rotating the rotatable wafer plate strips, and a housing that at least partially surrounds the rotatable wafer plate strips.

Example 15: The chuck device of Example 14, wherein the motor units comprise a separate servo motor for each of the rotatable wafer plate strips.

Example 16: The chuck device of any of Examples 14 and 15, wherein the chuck is moved to a polishing position above a polishing component to polish at least one of the edges of the wafer strips.

Example 17: The chuck device of any of Examples 14-16, wherein the blocking components are controlled by separate motor units and a separate controller.

Example 18: A method may include slicing a semiconductor wafer into one or more wafer strips, the wafer strips being supported by a corresponding rotatable wafer plate strip, the wafer strips having flat top surfaces and one or more edges, rotating the wafer strips on the rotatable wafer plate strips along a horizontal axis to expose one or more of the wafer strip edges for polishing, and polishing at least a portion of the wafer strip edges while the wafer strips are in the rotated, polishing position.

Example 19: The method of Example 18, further comprising rotating the pivot arm back to the cutting position to further cut the wafer strips into a plurality of wafer dies.

Example 20: The method of any of Examples 18 and 19, further comprising rotating the chuck from the cutting position to the rotated, polishing position to polish at least one edge of the wafer dies.

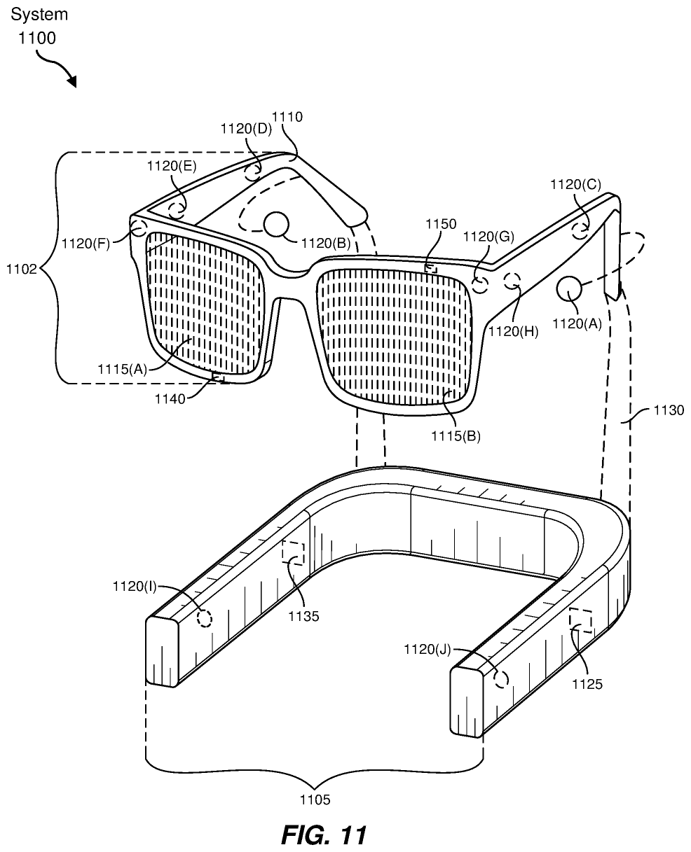

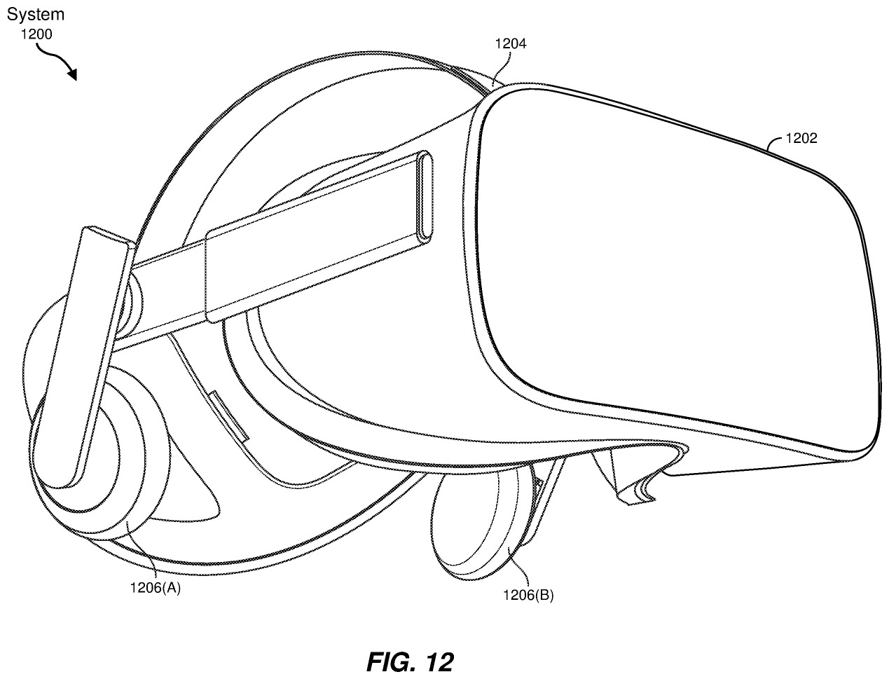

Embodiments of the present disclosure may include or be implemented in conjunction with various types of artificial-reality systems. Indeed, in at least some embodiments, polished semiconductor dies produced using the systems herein may be implemented in artificial reality devices including those shown in FIGS. 11 and 12. Artificial reality is a form of reality that has been adjusted in some manner before presentation to a user, which may include, for example, a virtual reality, an augmented reality, a mixed reality, a hybrid reality, or some combination and/or derivative thereof. Artificial-reality content may include completely computer-generated content or computer-generated content combined with captured (e.g., real-world) content. The artificial-reality content may include video, audio, haptic feedback, or some combination thereof, any of which may be presented in a single channel or in multiple channels (such as stereo video that produces a three-dimensional (3D) effect to the viewer). Additionally, in some embodiments, artificial reality may also be associated with applications, products, accessories, services, or some combination thereof, that are used to, for example, create content in an artificial reality and/or are otherwise used in (e.g., to perform activities in) an artificial reality.

Artificial-reality systems may be implemented in a variety of different form factors and configurations. Some artificial-reality systems may be designed to work without near-eye displays (NEDs). Other artificial-reality systems may include an NED that also provides visibility into the real world (such as, e.g., augmented-reality system 1100 in FIG. 11) or that visually immerses a user in an artificial reality (such as, e.g., virtual-reality system 1200 in FIG. 12). While some artificial-reality devices may be self-contained systems, other artificial-reality devices may communicate and/or coordinate with external devices to provide an artificial-reality experience to a user. Examples of such external devices include handheld controllers, mobile devices, desktop computers, devices worn by a user, devices worn by one or more other users, and/or any other suitable external system.

Turning to FIG. 11, augmented-reality system 1100 may include an eyewear device 1102 with a frame 1110 configured to hold a left display device 1115(A) and a right display device 1115(B) in front of a user's eyes. Display devices 1115(A) and 1115(B) may act together or independently to present an image or series of images to a user. While augmented-reality system 1100 includes two displays, embodiments of this disclosure may be implemented in augmented-reality systems with a single NED or more than two NEDs.

In some embodiments, augmented-reality system 1100 may include one or more sensors, such as sensor 1140. Sensor 1140 may generate measurement signals in response to motion of augmented-reality system 1100 and may be located on substantially any portion of frame 1110. Sensor 1140 may represent one or more of a variety of different sensing mechanisms, such as a position sensor, an inertial measurement unit (IMU), a depth camera assembly, a structured light emitter and/or detector, or any combination thereof. In some embodiments, augmented-reality system 1100 may or may not include sensor 1140 or may include more than one sensor. In embodiments in which sensor 1140 includes an IMU, the IMU may generate calibration data based on measurement signals from sensor 1140. Examples of sensor 1140 may include, without limitation, accelerometers, gyroscopes, magnetometers, other suitable types of sensors that detect motion, sensors used for error correction of the IMU, or some combination thereof.

In some examples, augmented-reality system 1100 may also include a microphone array with a plurality of acoustic transducers 1120(A)-1120(J), referred to collectively as acoustic transducers 1120. Acoustic transducers 1120 may represent transducers that detect air pressure variations induced by sound waves. Each acoustic transducer 1120 may be configured to detect sound and convert the detected sound into an electronic format (e.g., an analog or digital format). The microphone array in FIG. 11 may include, for example, ten acoustic transducers: 1120(A) and 1120(B), which may be designed to be placed inside a corresponding ear of the user, acoustic transducers 1120(C), 1120(D), 1120(E), 1120(F), 1120(G), and 1120(H), which may be positioned at various locations on frame 1110, and/or acoustic transducers 1120(1) and 1120(J), which may be positioned on a corresponding neckband 1105.

In some embodiments, one or more of acoustic transducers 1120(A)-(J) may be used as output transducers (e.g., speakers). For example, acoustic transducers 1120(A) and/or 1120(B) may be earbuds or any other suitable type of headphone or speaker.

The configuration of acoustic transducers 1120 of the microphone array may vary. While augmented-reality system 1100 is shown in FIG. 11 as having ten acoustic transducers 1120, the number of acoustic transducers 1120 may be greater or less than ten. In some embodiments, using higher numbers of acoustic transducers 1120 may increase the amount of audio information collected and/or the sensitivity and accuracy of the audio information. In contrast, using a lower number of acoustic transducers 1120 may decrease the computing power required by an associated controller 1150 to process the collected audio information. In addition, the position of each acoustic transducer 1120 of the microphone array may vary. For example, the position of an acoustic transducer 1120 may include a defined position on the user, a defined coordinate on frame 1110, an orientation associated with each acoustic transducer 1120, or some combination thereof.

Acoustic transducers 1120(A) and 1120(B) may be positioned on different parts of the user's ear, such as behind the pinna, behind the tragus, and/or within the auricle or fossa. Or, there may be additional acoustic transducers 1120 on or surrounding the ear in addition to acoustic transducers 1120 inside the ear canal. Having an acoustic transducer 1120 positioned next to an ear canal of a user may enable the microphone array to collect information on how sounds arrive at the ear canal. By positioning at least two of acoustic transducers 1120 on either side of a user's head (e.g., as binaural microphones), augmented-reality device 1100 may simulate binaural hearing and capture a 3D stereo sound field around about a user's head. In some embodiments, acoustic transducers 1120(A) and 1120(B) may be connected to augmented-reality system 1100 via a wired connection 1130, and in other embodiments acoustic transducers 1120(A) and 1120(B) may be connected to augmented-reality system 1100 via a wireless connection (e.g., a BLUETOOTH connection). In still other embodiments, acoustic transducers 1120(A) and 1120(B) may not be used at all in conjunction with augmented-reality system 1100.

Acoustic transducers 1120 on frame 1110 may be positioned in a variety of different ways, including along the length of the temples, across the bridge, above or below display devices 1115(A) and 1115(B), or some combination thereof. Acoustic transducers 1120 may also be oriented such that the microphone array is able to detect sounds in a wide range of directions surrounding the user wearing the augmented-reality system 1100. In some embodiments, an optimization process may be performed during manufacturing of augmented-reality system 1100 to determine relative positioning of each acoustic transducer 1120 in the microphone array.

In some examples, augmented-reality system 1100 may include or be connected to an external device (e.g., a paired device), such as neckband 1105. Neckband 1105 generally represents any type or form of paired device. Thus, the following discussion of neckband 1105 may also apply to various other paired devices, such as charging cases, smart watches, smart phones, wrist bands, other wearable devices, hand-held controllers, tablet computers, laptop computers, other external compute devices, etc.

As shown, neckband 1105 may be coupled to eyewear device 1102 via one or more connectors. The connectors may be wired or wireless and may include electrical and/or non-electrical (e.g., structural) components. In some cases, eyewear device 1102 and neckband 1105 may operate independently without any wired or wireless connection between them. While FIG. 11 illustrates the components of eyewear device 1102 and neckband 1105 in example locations on eyewear device 1102 and neckband 1105, the components may be located elsewhere and/or distributed differently on eyewear device 1102 and/or neckband 1105. In some embodiments, the components of eyewear device 1102 and neckband 1105 may be located on one or more additional peripheral devices paired with eyewear device 1102, neckband 1105, or some combination thereof.

Pairing external devices, such as neckband 1105, with augmented-reality eyewear devices may enable the eyewear devices to achieve the form factor of a pair of glasses while still providing sufficient battery and computation power for expanded capabilities. Some or all of the battery power, computational resources, and/or additional features of augmented-reality system 1100 may be provided by a paired device or shared between a paired device and an eyewear device, thus reducing the weight, heat profile, and form factor of the eyewear device overall while still retaining desired functionality. For example, neckband 1105 may allow components that would otherwise be included on an eyewear device to be included in neckband 1105 since users may tolerate a heavier weight load on their shoulders than they would tolerate on their heads. Neckband 1105 may also have a larger surface area over which to diffuse and disperse heat to the ambient environment. Thus, neckband 1105 may allow for greater battery and computation capacity than might otherwise have been possible on a standalone eyewear device. Since weight carried in neckband 1105 may be less invasive to a user than weight carried in eyewear device 1102, a user may tolerate wearing a lighter eyewear device and carrying or wearing the paired device for greater lengths of time than a user would tolerate wearing a heavy standalone eyewear device, thereby enabling users to more fully incorporate artificial-reality environments into their day-to-day activities.

Neckband 1105 may be communicatively coupled with eyewear device 1102 and/or to other devices. These other devices may provide certain functions (e.g., tracking, localizing, depth mapping, processing, storage, etc.) to augmented-reality system 1100. In the embodiment of FIG. 11, neckband 1105 may include two acoustic transducers (e.g., 1120(1) and 1120(J)) that are part of the microphone array (or potentially form their own microphone subarray). Neckband 1105 may also include a controller 1125 and a power source 1135.

Acoustic transducers 1120(1) and 1120(J) of neckband 1105 may be configured to detect sound and convert the detected sound into an electronic format (analog or digital). In the embodiment of FIG. 11, acoustic transducers 1120(1) and 1120(J) may be positioned on neckband 1105, thereby increasing the distance between the neckband acoustic transducers 1120(1) and 1120(J) and other acoustic transducers 1120 positioned on eyewear device 1102. In some cases, increasing the distance between acoustic transducers 1120 of the microphone array may improve the accuracy of beamforming performed via the microphone array. For example, if a sound is detected by acoustic transducers 1120(C) and 1120(D) and the distance between acoustic transducers 1120(C) and 1120(D) is greater than, e.g., the distance between acoustic transducers 1120(D) and 1120(E), the determined source location of the detected sound may be more accurate than if the sound had been detected by acoustic transducers 1120(D) and 1120(E).

Controller 1125 of neckband 1105 may process information generated by the sensors on neckband 1105 and/or augmented-reality system 1100. For example, controller 1125 may process information from the microphone array that describes sounds detected by the microphone array. For each detected sound, controller 1125 may perform a direction-of-arrival (DOA) estimation to estimate a direction from which the detected sound arrived at the microphone array. As the microphone array detects sounds, controller 1125 may populate an audio data set with the information. In embodiments in which augmented-reality system 1100 includes an inertial measurement unit, controller 1125 may compute all inertial and spatial calculations from the IMU located on eyewear device 1102. A connector may convey information between augmented-reality system 1100 and neckband 1105 and between augmented-reality system 1100 and controller 1125. The information may be in the form of optical data, electrical data, wireless data, or any other transmittable data form. Moving the processing of information generated by augmented-reality system 1100 to neckband 1105 may reduce weight and heat in eyewear device 1102, making it more comfortable to the user.

Power source 1135 in neckband 1105 may provide power to eyewear device 1102 and/or to neckband 1105. Power source 1135 may include, without limitation, lithium ion batteries, lithium-polymer batteries, primary lithium batteries, alkaline batteries, or any other form of power storage. In some cases, power source 1135 may be a wired power source. Including power source 1135 on neckband 1105 instead of on eyewear device 1102 may help better distribute the weight and heat generated by power source 1135.

As noted, some artificial-reality systems may, instead of blending an artificial reality with actual reality, substantially replace one or more of a user's sensory perceptions of the real world with a virtual experience. One example of this type of system is a head-worn display system, such as virtual-reality system 1200 in FIG. 12, that mostly or completely covers a user's field of view. Virtual-reality system 1200 may include a front rigid body 1202 and a band 1204 shaped to fit around a user's head. Virtual-reality system 1200 may also include output audio transducers 1206(A) and 1206(B). Furthermore, while not shown in FIG. 12, front rigid body 1202 may include one or more electronic elements, including one or more electronic displays, one or more inertial measurement units (IMUS), one or more tracking emitters or detectors, and/or any other suitable device or system for creating an artificial-reality experience.

Artificial-reality systems may include a variety of types of visual feedback mechanisms. For example, display devices in augmented-reality system 1100 and/or virtual-reality system 1200 may include one or more liquid crystal displays (LCDs), light emitting diode (LED) displays, microLED displays, organic LED (OLED) displays, digital light project (DLP) micro-displays, liquid crystal on silicon (LCoS) micro-displays, and/or any other suitable type of display screen. These artificial-reality systems may include a single display screen for both eyes or may provide a display screen for each eye, which may allow for additional flexibility for varifocal adjustments or for correcting a user's refractive error. Some of these artificial-reality systems may also include optical subsystems having one or more lenses (e.g., conventional concave or convex lenses, Fresnel lenses, adjustable liquid lenses, etc.) through which a user may view a display screen. These optical subsystems may serve a variety of purposes, including to collimate (e.g., make an object appear at a greater distance than its physical distance), to magnify (e.g., make an object appear larger than its actual size), and/or to relay (to, e.g., the viewer's eyes) light. These optical subsystems may be used in a non-pupil-forming architecture (such as a single lens configuration that directly collimates light but results in so-called pincushion distortion) and/or a pupil-forming architecture (such as a multi-lens configuration that produces so-called barrel distortion to nullify pincushion distortion).

In addition to or instead of using display screens, some of the artificial-reality systems described herein may include one or more projection systems. For example, display devices in augmented-reality system 1100 and/or virtual-reality system 1200 may include micro-LED projectors that project light (using, e.g., a waveguide) into display devices, such as clear combiner lenses that allow ambient light to pass through. The display devices may refract the projected light toward a user's pupil and may enable a user to simultaneously view both artificial-reality content and the real world. The display devices may accomplish this using any of a variety of different optical components, including waveguide components (e.g., holographic, planar, diffractive, polarized, and/or reflective waveguide elements), light-manipulation surfaces and elements (such as diffractive, reflective, and refractive elements and gratings), coupling elements, etc. Artificial-reality systems may also be configured with any other suitable type or form of image projection system, such as retinal projectors used in virtual retina displays.

The artificial-reality systems described herein may also include various types of computer vision components and subsystems. For example, augmented-reality system 1100 and/or virtual-reality system 1200 may include one or more optical sensors, such as two-dimensional (2D) or 3D cameras, structured light transmitters and detectors, time-of-flight depth sensors, single-beam or sweeping laser rangefinders, 3D LiDAR sensors, and/or any other suitable type or form of optical sensor. An artificial-reality system may process data from one or more of these sensors to identify a location of a user, to map the real world, to provide a user with context about real-world surroundings, and/or to perform a variety of other functions.

The artificial-reality systems described herein may also include one or more input and/or output audio transducers. Output audio transducers may include voice coil speakers, ribbon speakers, electrostatic speakers, piezoelectric speakers, bone conduction transducers, cartilage conduction transducers, tragus-vibration transducers, and/or any other suitable type or form of audio transducer. Similarly, input audio transducers may include condenser microphones, dynamic microphones, ribbon microphones, and/or any other type or form of input transducer. In some embodiments, a single transducer may be used for both audio input and audio output.

In some embodiments, the artificial-reality systems described herein may also include tactile (i.e., haptic) feedback systems, which may be incorporated into headwear, gloves, body suits, handheld controllers, environmental devices (e.g., chairs, floormats, etc.), and/or any other type of device or system. Haptic feedback systems may provide various types of cutaneous feedback, including vibration, force, traction, texture, and/or temperature. Haptic feedback systems may also provide various types of kinesthetic feedback, such as motion and compliance. Haptic feedback may be implemented using motors, piezoelectric actuators, fluidic systems, and/or a variety of other types of feedback mechanisms. Haptic feedback systems may be implemented independent of other artificial-reality devices, within other artificial-reality devices, and/or in conjunction with other artificial-reality devices.

By providing haptic sensations, audible content, and/or visual content, artificial-reality systems may create an entire virtual experience or enhance a user's real-world experience in a variety of contexts and environments. For instance, artificial-reality systems may assist or extend a user's perception, memory, or cognition within a particular environment. Some systems may enhance a user's interactions with other people in the real world or may enable more immersive interactions with other people in a virtual world. Artificial-reality systems may also be used for educational purposes (e.g., for teaching or training in schools, hospitals, government organizations, military organizations, business enterprises, etc.), entertainment purposes (e.g., for playing video games, listening to music, watching video content, etc.), and/or for accessibility purposes (e.g., as hearing aids, visual aids, etc.). The embodiments disclosed herein may enable or enhance a user's artificial-reality experience in one or more of these contexts and environments and/or in other contexts and environments.

As detailed above, the computing devices and systems described and/or illustrated herein broadly represent any type or form of computing device or system capable of executing computer-readable instructions, such as those contained within the modules described herein. In their most basic configuration, these computing device(s) may each include at least one memory device and at least one physical processor.

In some examples, the term “memory device” generally refers to any type or form of volatile or non-volatile storage device or medium capable of storing data and/or computer-readable instructions. In one example, a memory device may store, load, and/or maintain one or more of the modules described herein. Examples of memory devices include, without limitation, Random Access Memory (RAM), Read Only Memory (ROM), flash memory, Hard Disk Drives (HDDs), Solid-State Drives (SSDs), optical disk drives, caches, variations or combinations of one or more of the same, or any other suitable storage memory.

In some examples, the term “physical processor” generally refers to any type or form of hardware-implemented processing unit capable of interpreting and/or executing computer-readable instructions. In one example, a physical processor may access and/or modify one or more modules stored in the above-described memory device. Examples of physical processors include, without limitation, microprocessors, microcontrollers, Central Processing Units (CPUs), Field-Programmable Gate Arrays (FPGAs) that implement softcore processors, Application-Specific Integrated Circuits (ASICs), portions of one or more of the same, variations or combinations of one or more of the same, or any other suitable physical processor.

Although illustrated as separate elements, the modules described and/or illustrated herein may represent portions of a single module or application. In addition, in certain embodiments one or more of these modules may represent one or more software applications or programs that, when executed by a computing device, may cause the computing device to perform one or more tasks. For example, one or more of the modules described and/or illustrated herein may represent modules stored and configured to run on one or more of the computing devices or systems described and/or illustrated herein. One or more of these modules may also represent all or portions of one or more special-purpose computers configured to perform one or more tasks.

In addition, one or more of the modules described herein may transform data, physical devices, and/or representations of physical devices from one form to another. Additionally or alternatively, one or more of the modules recited herein may transform a processor, volatile memory, non-volatile memory, and/or any other portion of a physical computing device from one form to another by executing on the computing device, storing data on the computing device, and/or otherwise interacting with the computing device.

In some embodiments, the term “computer-readable medium” generally refers to any form of device, carrier, or medium capable of storing or carrying computer-readable instructions. Examples of computer-readable media include, without limitation, transmission-type media, such as carrier waves, and non-transitory-type media, such as magnetic-storage media (e.g., hard disk drives, tape drives, and floppy disks), optical-storage media (e.g., Compact Disks (CDs), Digital Video Disks (DVDs), and BLU-RAY disks), electronic-storage media (e.g., solid-state drives and flash media), and other distribution systems.

The process parameters and sequence of the steps described and/or illustrated herein are given by way of example only and can be varied as desired. For example, while the steps illustrated and/or described herein may be shown or discussed in a particular order, these steps do not necessarily need to be performed in the order illustrated or discussed. The various exemplary methods described and/or illustrated herein may also omit one or more of the steps described or illustrated herein or include additional steps in addition to those disclosed.

The preceding description has been provided to enable others skilled in the art to best utilize various aspects of the exemplary embodiments disclosed herein. This exemplary description is not intended to be exhaustive or to be limited to any precise form disclosed. Many modifications and variations are possible without departing from the spirit and scope of the present disclosure. The embodiments disclosed herein should be considered in all respects illustrative and not restrictive. Reference should be made to the appended claims and their equivalents in determining the scope of the present disclosure.

Unless otherwise noted, the terms “connected to” and “coupled to” (and their derivatives), as used in the specification and claims, are to be construed as permitting both direct and indirect (i.e., via other elements or components) connection. In addition, the terms “a” or “an,” as used in the specification and claims, are to be construed as meaning “at least one of.” Finally, for ease of use, the terms “including” and “having” (and their derivatives), as used in the specification and claims, are interchangeable with and have the same meaning as the word “comprising.”

What is claimed is:

1. A system comprising:
a slicing component having a cutting blade that is configured to cut a semiconductor wafer into a plurality of wafer strips, the wafer strips having flat top surfaces and one or more edges;
a chuck that includes one or more rotatable wafer plate strips that are respectively configured to support the plurality of wafer strips that are cut by the cutting blade;
a pivot arm configured to rotate the chuck from a cutting position that faces the slicing component to a rotated, polishing position that faces a polishing component, such that at least an exposed edge of the wafer strips faces the polishing component; and
the polishing component that is configured to polish at least a portion of the exposed edge of the wafer strips facing the polishing component.

2. The system of claim 1, further comprising a loading and unloading station configured to receive and offload the semiconductor wafer.

3. The system of claim 2, wherein the pivot arm transfers the semiconductor wafer from the loading and unloading station to the slicing component.

4. The system of claim 1, wherein the wafer strips are rotated about a transverse axis relative to the chuck, allowing the exposed edge of the wafer strips to at least partially face the polishing component.

5. The system of claim 4, wherein the chuck further comprises a plurality of blocking components configured to support the rotated wafer plate strips.

6. The system of claim 4, wherein the wafer plate strips are rotated under the control of at least one servo motor.

7. The system of claim 1, wherein the pivot arm is further configured to subsequently rotate the chuck, allowing the cutting blade of the slicing component to cut the wafer strips into a plurality of wafer dies.

8. The system of claim 7, wherein the pivot arm subsequently rotates the chuck from the cutting position to the rotated, polishing position to polish a second exposed edge of the wafer dies.

9. The system of claim 1, wherein the polishing component comprises a chemical-mechanical planarization (CMP) machine.

10. The system of claim 1, wherein the semiconductor wafer comprises a photonics integrated circuit.

11. The system of claim 1, wherein the chuck is configured to rotate the rotatable wafer plate strips to a specified angle, such that the exposed edge of the wafer strips are polished at the specified angle.

12. The system of claim 11, wherein different edges of the same wafer strip are polished at different angles.

13. The system of claim 11, wherein the exposed edges of different wafer strips are polished at offset angles that allow the exposed edges of the different wafer strips to abut each other.

14. A chuck device comprising:
one or more rotatable wafer plate strips that are configured to support one or more corresponding wafer strips that have been cut from a semiconductor wafer, the wafer strips including one or more edges;
one or more blocking components that are configured to abut the wafer plate strips and, upon the rotatable wafer plate strips being at least partially rotated, are configured to extend to at least one edge of the semiconductor wafer;
one or more motor units configured to perform at least one of moving the blocking components or rotating the rotatable wafer plate strips; and
a housing that at least partially surrounds the rotatable wafer plate strips.

15. The chuck device of claim 14, wherein the motor units comprise separate servo motors for the rotatable wafer plate strips.

16. The chuck device of claim 14, wherein the chuck is moved to a polishing position above a polishing component to polish at least one of the edges of the wafer strips.

17. The chuck device of claim 14, wherein the blocking components are controlled by separate motor units and a separate controller.

18. A method comprising:
slicing a semiconductor wafer into one or more wafer strips, the wafer strips being supported by a corresponding rotatable wafer plate strip, the wafer strips having flat top surfaces and one or more edges;
rotating the wafer strips on the rotatable wafer plate strips along a horizontal axis to expose one or more of the wafer strip edges for polishing; and
polishing at least a portion of the wafer strip edges while the wafer strips are in the rotated, polishing position.

19. The method of claim 18, further comprising rotating a chuck via a pivot arm back to a cutting position to further cut the wafer strips into a plurality of wafer dies.

20. The method of claim 19, further comprising rotating the chuck from the cutting position to the rotated, polishing position to polish at least one edge of the wafer dies.
